(19) United States
(12) Patent Application Publication
(10) Pub. No.: US 2011/0287342 A1
(43) Pub. Date: Nov. 24, 2011

(54) Porous membrane for fuel cell electrolyte membrane and method for manufacturing the same

(75) Inventor: Hiroshi Harada, Aichi (JP)

(73) Assignee: Toyota Jidosha Kabushiki Kaisha

(21) Appl. No.: 13/067,864

(22) Filed: Jun. 30, 2011

Related U.S. Application Data
(62) Division of application No. 12/304,806, filed on Dec. 15, 2008.

(30) Foreign Application Priority Data
Jun. 26, 2006 (JP) 2006-175631

(51) Int. Cl. H01M 8/00; H01M 8/10

(52) U.S. Cl. 429/535

(57) ABSTRACT

To obtain a porous membrane for a fuel cell electrolyte membrane, having mechanical property which is equal in the longitudinal and lateral directions. A porous membrane 10 is formed in such a way that porous resin sheets 1a and 1b which are obtained by uniaxially stretching a polytetrafluoroethylene thin membrane and which have strength anisotropy in orthogonal two directions, are mutually laminated in a state where the directions in which the strength of the porous resin sheets is large are made to cross each other, and that the laminated porous resin sheets are integrally bonded by means of heat fusion, or the like.

### TECHNICAL FIELD

The present invention relates to a porous membrane used as a reinforcing material in a fuel cell electrolyte membrane, and a method for manufacturing the porous membrane. Further, the present invention relates to an electrolyte membrane and a membrane electrode assembly which include the porous membrane.

### BACKGROUND ART

A solid polymer fuel cell is known as one form of a fuel cell. The solid polymer fuel cell uses a membrane electrode assembly (MEA) 50 as a main component, as shown in FIG. 4. The membrane electrode assembly is held between separators 51 and 51 having fuel (hydrogen) gas passages and air gas passages, so as to thereby form a fuel cell 52 referred to as a unit cell. The membrane electrode assembly 50 has a structure in which an anode side electrode catalyst layer 56a and a diffusion layer 57a are laminated on one side of an electrolyte membrane 55 which is an ion exchange membrane, and in which a cathode side electrode catalyst layer 56b and a diffusion layer 57b are laminated on the other side of the electrolyte membrane 55.

As the electrolyte membrane 55, a thin membrane of a perfluorosulfonic acid polymer (Nafion membrane made by Du Pont Co. Ltd., U.S.A.) which is an electrolyte resin (ion exchange resin), is mainly used. However, it is not possible to obtain sufficient strength by the perfluorosulfonic acid polymer itself. Therefore, for example, a reinforced electrolyte membrane is also formed in such a way that a porous membrane porosified by uniaxially or biaxially stretching a thin membrane made of polytetrafluoroethylene, high molecular weight polyethylene resin, or the like, is used as a reinforcing material, and that an electrolyte resin solution is impregnated in the porous membrane (see Patent Document 1, Patent Document 2, and the like).

Patent Document 1: JP Patent Publication (Kokai) No. 8-13179

Patent Document 2: JP Patent Publication (Kokai) No. 9-194609

In the membrane electrode assembly formed by using the above described reinforced electrolyte membrane, it is desired that the mechanical property in the membrane surface of the porous membrane serving as a reinforcing material, is equal in both the longitudinal and lateral directions. If the mechanical property ratio between the longitudinal and lateral directions is large, the difference between the longitudinal and lateral dimensional changes is increased at the time of expansion of the electrolyte. Thereby, a large stress strain difference between the longitudinal and lateral directions is generated in the interface between the electrode catalyst layer and the electrolyte membrane. When such stress strain difference is generated, the reaction unevenness, the interfacial peeling, and the like, may be caused, so as to significantly affect the durability as the cell.

The porous membrane obtained by uniaxial stretching is highly oriented in the stretched direction, and has a fiber direction aligned in the stretched direction. Thereby, the strength of the porous membrane is increased in the stretched direction. However, the porous membrane has a low orientation in the direction orthogonal to the stretched direction. This inevitably causes a large strength anisotropy to be generated in the orthogonal two directions. Thereby, the mechanical property ratio in the longitudinal and lateral directions becomes large in the membrane surface of the porous membrane. Thus, in the electrolyte membrane in which the porous membrane obtained by uniaxial stretching is used as a reinforcing material, an appreciable stress strain difference may be generated in the interface between the electrode catalyst layer and the electrolyte membrane by the operation of the fuel cell.

In a porous membrane obtained by stretching in orthogonal two directions (that is, formed by isotropic stretching), the strength anisotropy in the longitudinal and lateral directions in the membrane surface is reduced as compared with the porous membrane obtained by uniaxial stretching. However, the strength anisotropy is extremely difficult to be eliminated. Further, in the case of biaxial stretching, it is difficult to form a membrane with a high stretching ratio (high orientation) as compared with the case of uniaxial stretching, so that a required strength as the porous membrane may be unable to be obtained.

In manufacturing the conventional reinforced electrolyte membrane as described in Patent Documents 1 and Patent Document 2, the above described problem relating to the strength anisotropy of the porous membrane, which is caused by the stretching process at the time of manufacturing the membrane, has not been recognized in particular. In recent years, according to the requirement for the practical use of a fuel cell having higher power generation performance, it has become an important problem to impart a mechanical property which is equal in the longitudinal and lateral directions, to the porous membrane used as the reinforcing material.

The present invention has been made in view of the above described circumstances. An object of the present invention is to provide a porous membrane for a fuel cell electrolyte membrane, which has mechanical property equal in the longitudinal and lateral directions, and to provide a method for manufacturing the porous membrane. A further object of the present invention is to provide a reinforced electrolyte membrane and a membrane electrode assembly which include the porous membrane.

### DISCLOSURE OF THE INVENTION

A porous membrane for a fuel cell electrolyte membrane according to the present invention is characterized in that two or more sheets of porous resin sheets having strength anisotropy in orthogonal two directions are laminated and bonded with each other in a state where the directions in which the strength of the porous resin sheets is high are made to cross each other.

Further, a method for manufacturing the porous membrane for a fuel cell electrolyte membrane, according to the present invention, is characterized by including at least: a step of mutually laminating two or more sheets of porous resin sheets having strength anisotropy in orthogonal two directions, in a state where the directions in which the strength of the porous resin sheets is high are made to cross each other; and a step of bonding the laminated porous resin sheets to each other.

In the present invention, a resin material used as a starting material of the porous resin sheet, may be a resin material used for manufacturing a porous membrane used in a conventional reinforced electrolyte membrane. Preferably, there are listed, as the resin material, polytetrafluoroethylene resin, high molecular weight polyethylene resin, and the like. In particular, polytetrafluoroethylene resin is preferred in terms of ease of stretching. A thin membrane of the resin is formed by a prescribed method, and is uniaxially stretched by a conventionally known method. Thereby, a porous resin sheet having strength anisotropy in orthogonal two directions is obtained. A porous membrane for a fuel cell electrolyte membrane according to the present invention is obtained in such a way that two or more sheets of the obtained porous resin sheets are mutually laminated in a state where the directions in which the strength of the porous resin sheets is high are made to cross each other, and that the laminated porous resin sheets are bonded to each other by a suitable method. The angle at which the high strength directions are made to cross each other is preferably 90 degrees, but the angle may be smaller or larger than 90 degrees.

In the porous membrane for a fuel cell electrolyte membrane, which is obtained by the manufacturing method according to the present invention, the porous resin sheets obtained by stretching only in one axial direction are fundamentally used by being laminated with each other. When a resin sheet is stretched only in one axial direction, it is possible to make the resin sheet have a higher molecular orientation as compared with the case where the same resin sheet is stretched in orthogonal two directions. Thereby, the mechanical property (strength) of the uniaxially stretched resin sheet in the stretched direction is increased as compared with the mechanical property of the biaxially stretched resin sheet.

The porous resin sheets obtained in this way are mutually laminated in such a way that the directions (stretched directions) in which the strength of the resin sheets is high are made to cross each other. Thus, the mechanical property of the laminated body becomes substantially the same in the crossing two directions (the longitudinal and lateral directions). At the same time, the mechanical strength in the two directions is also higher than the mechanical strength obtained by stretching a single sheet in the orthogonal two directions. That is, the porous membrane according to the present invention is a porous membrane for a fuel cell electrolyte membrane, which has strength isotropy and a high strength.

It is preferred that the laminated porous resin sheets are heat fused with each other at the temperature, or higher, of the melting point of the laminated porous resin sheets, but the present invention is not limited to this. It is also possible to adopt a pressure bonding method by heat press, a bonding method based on interface fiberization which is performed by the stretching of the porous resin sheets in the laminated state, and the like. In this case, the bonding degree of the interface can be further increased by heat pressing the laminated porous resin sheets at the temperature of the melting point or lower before the stretching process.

A membrane for a fuel cell electrolyte membrane is formed by combining the porous membrane manufactured as described above and an electrolyte resin by a conventional method. A membrane electrode assembly is formed by laminating an electrode catalyst layer and a diffusion layer on the electrolyte membrane by a conventional method. In the obtained membrane electrode assembly, the mechanical property in the membrane surface of the porous membrane, which is provided in the electrolyte membrane as a reinforcing material, are equal in the longitudinal and lateral directions. Thus, the stress strain difference between the longitudinal and lateral directions is not generated in the interface between the electrode catalyst layer and the electrolyte membrane, due to the swelling at the time of power generation. As a result, it is possible to obtain a membrane electrode assembly having a high power generation performance and a long life.

According to the present invention, it is possible to obtain a porous membrane for a fuel cell electrolyte membrane, which is free from the strength anisotropy and has a high strength. A membrane electrode assembly including an electrolyte membrane which has the porous membrane according to the present invention as a reinforcing material, has a high power generation performance and a long life.

### BRIEF DESCRIPTION OF THE DRAWINGS

FIG. 1 is a figure explaining one aspect of manufacturing a porous membrane for a fuel cell electrolyte membrane by a method according to the present invention.

FIG. 2 is a figure explaining one aspect in which the porous membrane shown in FIG. 1 is combined with an electrolyte resin, so as to be formed into an electrolyte membrane.

FIG. 3 is a figure showing surface SEM images of the porous membranes of an embodiment and a comparison example.

FIG. 4 is a schematic view showing an example of a fuel cell.

### DESCRIPTION OF SYMBOLS

1 . . . Uniaxially stretched long-sized porous resin sheet, 1a, 1b . . . . Two sheets of porous resin sheets which are cut to a predetermined size and are laminated so that their stretched directions are orthogonal to each other, 10 . . . Porous membrane for fuel cell electrolyte membrane according to the present invention, 11 . . . Thin electrolyte resin membrane, 20 . . . Electrolyte membrane

### BEST MODE FOR CARRYING OUT THE INVENTION

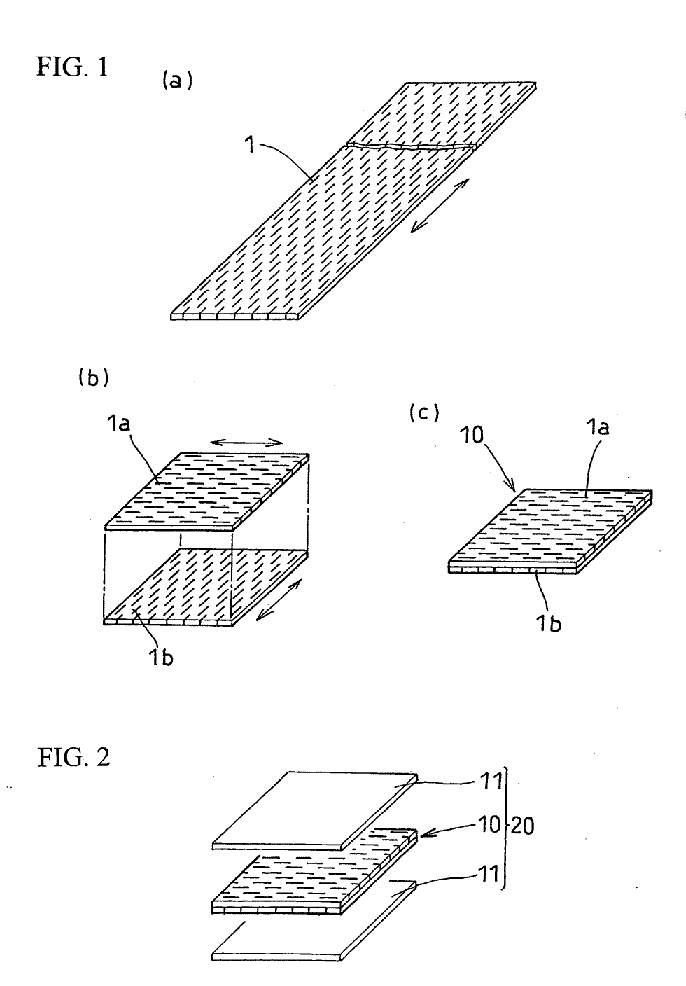

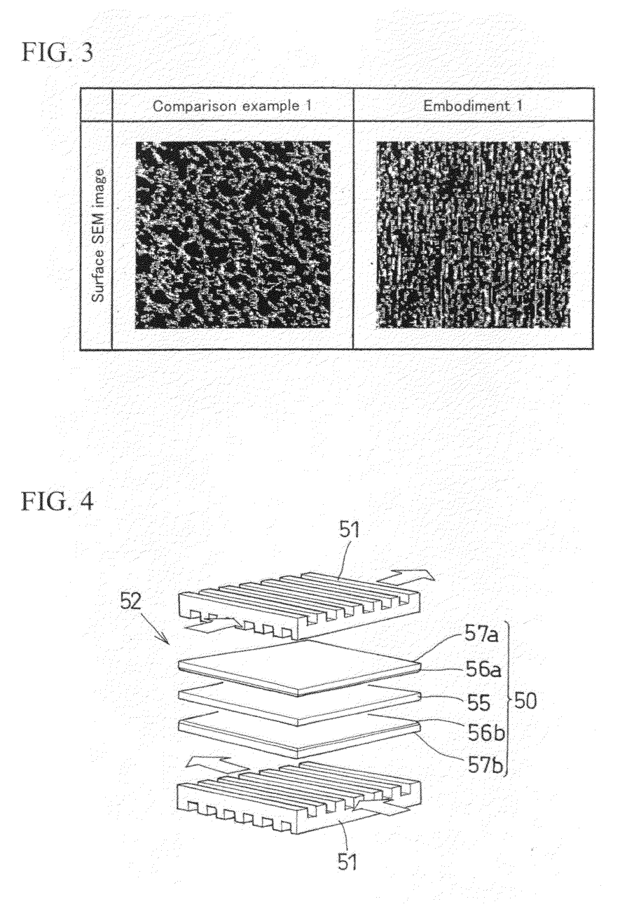

In the following, an embodiment according to the present invention will be described with reference to the accompanying drawings. FIG. 1 is a figure explaining one aspect of manufacturing a porous membrane for a fuel cell electrolyte membrane by a method according to the present invention. FIG. 2 is a figure explaining a state where the porous membrane shown in FIG. 1 is combined with an electrolyte resin, so as to be formed into an electrolyte membrane. Further, FIG. 3 is a figure showing surface SEM images of the porous membranes of an embodiment and a comparison example.

In manufacturing a porous membrane 10 for a fuel cell electrolyte membrane, according to the present invention, a porous resin sheet 1 stretched (oriented) in one axial direction (arrow direction) is first made as shown in FIG. 1a. The porous resin sheet 1 can be obtained by uniaxially stretching an unbaked tape by a conventional method, which unbaked tape is obtained in such a way that, for example, a fine powder of a polytetrafluoroethylene is kneaded with a lubricant additive so as to be in a paste state, and is then formed into a round bar-like bead by extrusion or the like, and that the round bar-like bead is rolled between a pair of metallic rolling rolls. The stretching ratio and the thickness of the porous resin sheet 1 are determined in consideration of the strength, and the like, which is required for the porous membrane to be obtained.

Porous resin sheets 1a and 1b of a predetermined size are cut out from the obtained long-sized porous resin sheet 1. Then, as shown in FIG. 1b, the porous resin sheets 1a and 1b are laminated in a state where the stretched directions (that is, the fiber orientation directions) of the respective sheets are set to be orthogonal to each other. After the lamination process, the two porous resin sheets 1a and 1b are bonded to each other by a suitable method, and thereby the porous membrane 10 for a fuel cell electrolyte membrane, according to the present invention, is obtained as shown in FIG. 1c. The bonding process can be performed by a method of performing heat fusion at the temperature, or higher, of the melting point temperature of the resin constituting the porous resin sheets 1a and 1b, a pressure bonding method by heat press, and the like. In any case, it is possible to obtain a firm bonding, by applying a suspension of the resin constituting the porous resin sheet to the interface at the time of lamination process.

Note that a porous membrane which is formed by making the obtained porous membrane 10 further stretched in one axial direction or stretched in orthogonal two axial directions, may also be used as a porous membrane for a fuel cell electrolyte membrane. In this case, it is possible to further promote fiberization of the membrane, and to thereby further improve the strength of the membrane. The porous membrane 10 may also be formed in such a way that a plurality of long-sized porous resin sheets 1″ are prepared, and that porous resin sheets 1a and 1b cut out from the respective long-sized porous resin sheets are laminated with each other. In this case, it is preferred that the mechanical property of the respective sheets is the same, but the mechanical property of the respective sheets may also be different. In any case, the respective sheets may be mutually laminated in such a state where the stretched directions (fiber orientation directions) of the sheets are made to cross each other.

Next, the obtained porous membrane 10 is combined with an electrolyte resin. The combining process is performed in such a way that the electrolyte resin is impregnated in the porous membrane 10 by immersing the porous membrane 10 in a solution of the electrolyte resin and is then dried, or that as shown in FIG. 2, thin membranes 11 and 11 of an electrolyte resin precursor are laminated on the porous membrane 10, and the laminated membranes are bonded to each other by heat-press bonding at the temperature which is the melting point of the porous membrane or lower, and which is the melting point (softening point) of the electrolyte resin precursor or higher. In the latter case, an electrolyte membrane is obtained by subjecting the bonded laminated membranes to hydrolysis with alkali (NaOH, KOH, or the like) and then to proton substitution with acid. Thereby, it is possible to obtain an electrolyte membrane 20 which has, as a reinforcing membrane, the porous membrane 10 for a fuel cell electrolyte membrane, according to the present invention. Further, although not shown, a membrane electrode assembly is formed by respectively laminating an electrode catalyst layer and a diffusion layer on the anode side and the cathode side of the obtained electrolyte membrane 20.

As described above, in the porous membrane 10 according to the present invention, the strength is isotropic, and the mechanical property is substantially the same in the longitudinal and lateral directions. Thus, in the membrane electrode assembly provided with the electrolyte membrane which has the porous membrane 10 as a reinforcing membrane, it is possible to prevent that the large stress strain difference between the longitudinal and lateral directions is generated in the interface between the electrode catalyst layer and the electrolyte membrane by the swelling and contraction at the time of power generation, and thereby possible to obtain a high power generation performance and a long life.

### EMBODIMENT

In the following, the present invention will be described by an embodiment and a comparison example.

### Embodiment

After a process of uniformly dispersing naphtha as a liquid lubricant in a fine powder of polytetrafluoroethylene (PTFE) and of preforming the obtained mixture, a round bar-like bead was obtained by subjecting the preformed mixture to paste extrusion. A long-sized unbaked tape was formed by making the bead be rolled between a pair of metallic rolling rolls. A fibril-like polytetrafluoroethylene resin porous sheet having a thickness of 7 μm was obtained by uniaxially and highly orienting (highly stretching) the tape (with stretching ratio of 10).

Two sheets having a size of 100 mm×100 mm were cut out from the obtained porous resin sheet, and were laminated so that the stretched directions are made to orthogonally cross each other. In laminating the sheets, the lamination interface between the sheets was coated by spraying a polytetrafluoroethylene suspension. The laminated sheets were heated at 360° C., so as to be integrally heat fused. As a result, a porous membrane for an electrolyte membrane, having a thickness of 14 to 15 μm, was obtained.

### Comparison Example

A long-sized unbaked tape A was obtained by a process similar to that of the embodiment. A fibril-like porous membrane for an electrolyte membrane, having a thickness of 14 to 15 μm and small anisotropy in physical properties (orientation and strength), was obtained by making the tape A biaxially stretched (10 times in the MD direction and 10 times in the TD direction).

[Evaluation Method]

a. Evaluation 1 (porous structure): in order to perform comparison between the porous structures (fiber states) of the porous membranes for the electrolyte membrane, respectively formed as the embodiment and the comparison example, the surface structures of the porous membranes were observed with an electron microscope. The obtained SEM images are shown in FIG. 3.

b. Evaluation 2 (porosity): In order to perform comparison between the porous structures, the volume (dimension×film thickness) and weight of the porous membranes were measured, and the porosity of the porous membranes was calculated by using the following Formula 1. The obtained results are shown in Table 1.

Porosity (%)=[1−(film weight)/((PTFE true density)×(membrane product))]×100 Formula 1

c. Evaluation 3 (mechanical strength): in order to perform comparison between the physical properties of the porous membranes, the tensile test of the porous membranes was performed and the yield stress of the porous membranes was measured. The mechanical strength of the resin itself constituting the porous membranes was calculated by such a way that the membrane strength as a porous membrane was calculated by compensating the obtained tensile stress with the cross-sectional area, and the obtained membrane strength was compensated with the porosity, as shown in the following Formula 2. The calculation was performed for the MD direction and the TD direction. The calculation results are shown in Table 1.

Resin strength (MPa)=(Film strength)/[1−(porosity)/100] Formula 2

TABLE 1

| | Porosity | Resin strength (kgf/mm²) | |
|---|---|---|---|
| | (%) | MD direction | TD direction |
| Embodiment | 75 | 35 | 35 |
| Comparison example | 80 | 25 | 23 |

[Result]

As shown in the SEM images of membrane surfaces in FIG. 3, it is seen that in the comparison example, the stretching process was similarly performed in the two axial directions and thereby the porous structure takes a radially homogeneous structure. On the other hand, in the present embodiment, the stretching process was performed in one axial direction, and hence the fiber direction is aligned. Therefore, it is expected that the strength in the fiber direction is high. Note that the SEM images of membrane surfaces shown in FIG. 3 were obtained by the observation from one side, but the rear surface of the membrane according to the present embodiment takes a structure formed by rotating the structure shown in the figure by 90 degrees (structure formed by orienting the fiber in the lateral direction). Therefore, the fibers of the membrane according to the present embodiment are highly oriented respectively in the two axial directions in the front and rear surfaces. Thus, it is expected that the membrane according to the present embodiment has a higher strength than that of the comparison example.

In fact, as shown in Table 1, the strength of the membrane according to the present embodiment is high in the two orthogonal axial directions (MD direction and TD direction) as compared with the comparison example. Further, it is also seen that the physical property difference between the MD direction and the TD direction is reduced. This exhibits the superiority of the porous membrane according to the present invention.

1. (canceled)

2. A method for manufacturing a porous membrane for a fuel cell electrolyte membrane at least comprising: a step of mutually laminating two or more sheets of porous resin sheets having strength anisotropy in orthogonal two directions in a state where the directions in which the strength of the porous resin sheets is high are made to cross each other; and a step of bonding the laminated porous resin sheets to each other.

3. The method for manufacturing a porous membrane for a fuel cell electrolyte membrane according to claim 2, wherein in the bonding step, the laminated porous resin sheets are heat fused with each other at the temperature, or higher, of the melting point of the laminated porous resin.

4. The method for manufacturing a porous membrane for a fuel cell electrolyte membrane according to claim 2, wherein a sheet formed by making polytetrafluoroethylene uniaxially stretched and porosified is used as the porous resin sheet to be laminated.

5. (canceled)

6. (canceled)
